(19) United States
(12) Patent Application Publication
(10) Pub. No.: US 2008/0151542 A1
(43) Pub. Date: Jun. 26, 2008

(54) Lighting System

(76) Inventor: Richard Graham Liddle, Newcastle (GB)

Correspondence Address: Jackson Walker L.L.P., 112 E. Pecan Street, Suite 2400, San Antonio, TX, 78205, US

(21) Appl. No.: 11/884,137

(22) PCT Filed: Feb. 7, 2006
(86) PCT No.: PCT/GB06/50030

§ 371 Date: Aug. 9, 2007

(30) Foreign Application Priority Data
Feb. 10, 2005 (GB) 0502725.5

(51) Int. Cl. F21V 11/00; F21V 21/00

(52) U.S. Cl. 362/240; 362/249

(57) ABSTRACT

A lighting element (1) comprises at least one light (3), means (13) for delivering electricity to the or each light, a pair of spaced apart plates (2,2′), at least one magnet (4,4′) located between the said plates and biasing means (8) for biasing the said plates apart, wherein a magnet (4) is attached to one of the pair of plates. In use the lighting element forms part of a lighting system in which the element is located between spaced apart transparent sheets (10), e.g. panes of glass.

### FIELD OF THE INVENTION

The invention relates to a lighting system, and in particular to a lighting system where a lighting element is mounted between transparent planar sheets.

### BACKGROUND OF THE INVENTION

Low voltage lighting is used within commercial and domestic environments, usually to produce lighting effects. Typically, low voltage lighting units consist of fixed assembled structures that are positioned and wired within the area required to be lit. Once positioned, the lighting units are stationary and rarely re-positioned.

Attempts have been made to make low voltage lighting units more flexible by providing for movement of lighting units relative to a supply of electricity.

DE 19826530 describes a lighting unit in which a low voltage lamp is slidably mounted on a rail. The supply of electricity is arranged such that the lamp is supplied with electricity at any position on the rail. Once a user has decided on the desired location of the lamp, the lamp is held in place by magnetic attraction between a magnet arrangement in the lamp assembly and the rail.

DE 4014818 describes a low voltage lighting system comprising parallel conductor rails, which supports one or more lamps and feeds electricity to them. The lamps can be moved along the rails and are held in place by a bar-magnet, which also forms an electrical contact.

Another lighting device is described in French patent application no 2,836,985. The lighting device of this patent comprises a lighting element mounted between an electrically conductive transparent surface and another electrically conductive surface. Electricity from the respective electrically conductive surfaces power the lighting element mounted therebetween. The lighting element includes two contacts each in electrical connection with one of the said electrically conductive surfaces. One of the contacts consists of a brush contact filament. The lighting element includes at least one magnet situated substantially adjacent to a backing plate. The lighting unit is held in place by a magnet aligned with the magnet of the lighting element, but on the other side of the backing plate. The lighting element may be moved by moving the magnet on the other side of the backing plate, and a hand-grip is provided to facilitate this.

There is a need for an improved lighting arrangement

### SUMMARY OF THE INVENTION

According to a first aspect of the invention, there is provided a lighting element as specified in Claim 1.

According to a second aspect of the invention, there is provided a lighting system as specified in Claim 14.

According to third aspect of the invention, there is provided a method of lighting as specified in Claim 20.

The electrical power supply to the lighting element may be low voltage direct current or an alternating current from a mains supply, i.e. for the UK 240 volts at 60 Hz.

The lighting system of the present invention provides a convenient means of lighting in which the lighting elements are mounted between transparent sheets and can be moved easily from one position to another simply by aligning magnets located outside the sheets with the lighting element. The magnets located outside the transparent sheet are attracted to magnets forming part of the lighting unit. The attraction of the magnets causes part of a plate mounting the lights to be pulled out of contact with an inner surface of one of the transparent sheets. This allows the lighting element to be re-positioned within the space between the sheets. The gravity switch allows the lighting elements to be switched on and off simply by rotating them.

### BRIEF DESCRIPTION OF THE DRAWINGS

In the drawings, which illustrate preferred embodiments of a lighting arrangement according to the invention:

FIG. 1 is a schematic representation of a lighting system according to the invention mounted between panes of glass;

FIG. 2 is a cross-sectional elevation of a lighting element of the system in FIG. 1;

FIG. 3 is a front view of the lighting element illustrated in FIGS. 2 and 3;

FIG. 4 is a side view of a lens of the lighting system illustrated in FIG. 1;

FIG. 5 is a front view of the lens illustrated in FIG. 4;

FIG. 6 is a cross-sectional elevation of the lighting system illustrated in FIG. 1;

FIG. 7 is a front view of an alternative embodiment of a lighting element;

FIG. 8 is a schematic representation of a switch; and

FIG. 9 is a side view of a second embodiment of a lens.

### DETAILED DESCRIPTION OF THE PREFERRED EMBODIMENTS

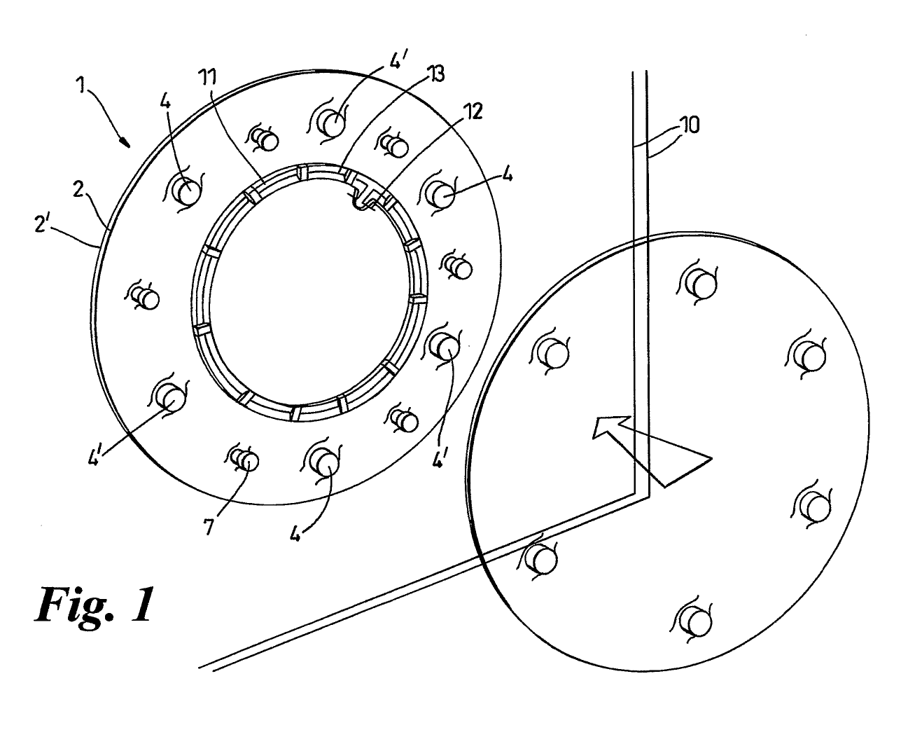

Referring now to FIG. 1, a lighting element 1 is mounted between a pair of spaced apart glass panes 10. The glass panes are conductive of electricity. In the example, the inner surface of each glass pane is coated with an electrically conductive layer 9. The lighting element 1 includes a plurality of light emitting diodes (LED's) 3. The central portion of each of the plates 2, 2′ is cutaway, with a ring mounting a plurality of LED's being mounted in the ring 11. The thickness of the ring 11 is slightly smaller than the distance between the outside walls of the plates 2, 2′. The ring 11 also mounts an electrical contact element 12, which is so dimensioned that the ends thereof brush the electrically conductive inner surfaces of the panes 10. Power is delivered to the LED's via the electrical contact element 12 and wires 13. The contact elements 12 may take the form of a single conductive polymer.

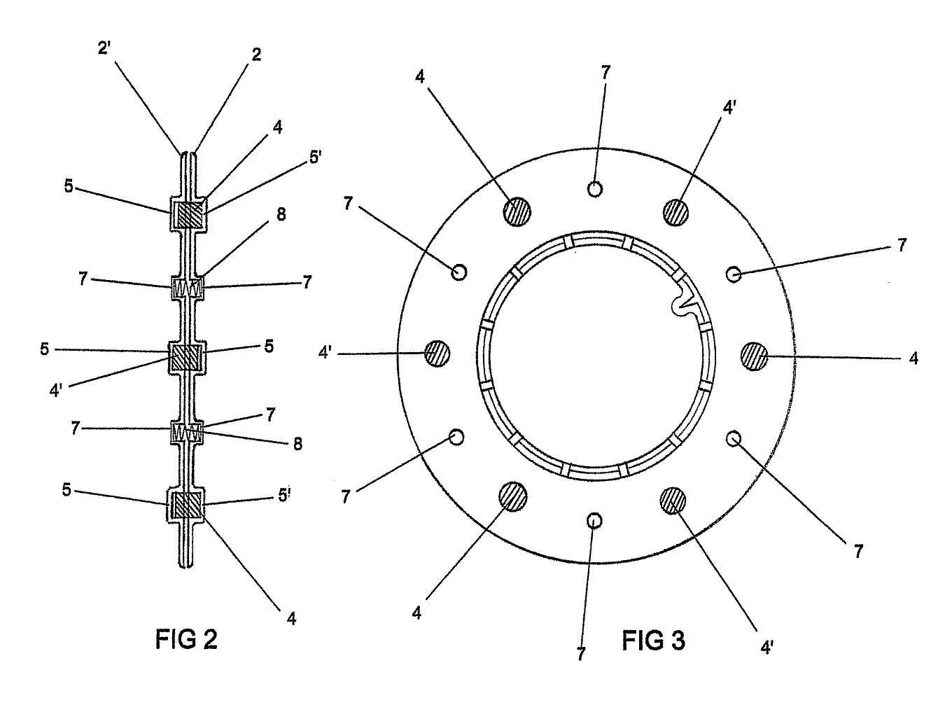

Referring now to FIGS. 1 to 3, magnets 4 and 4′ are arranged in recesses 5 in the plates 2, 2′. The magnets 4 and 4′ are bonded to a respective one of the plates 2, 2′. In particular, magnets 4 are bonded to the plate 2 and magnets 4′ are bonded to the plates 2′. The plates 2 and 2′ include further recesses 7, which are aligned as can be seen from FIG. 2. Compression springs 8 are located in the recesses 7 and serve to force apart the plates 2, 2′. The compression springs 8 may take the form of compressed foam, sponge or a plastics material. Where the springs 8 are formed from a plastics material, the springs 8 may be formed as part of the vacuum forming of one of the plates 2, 2′.

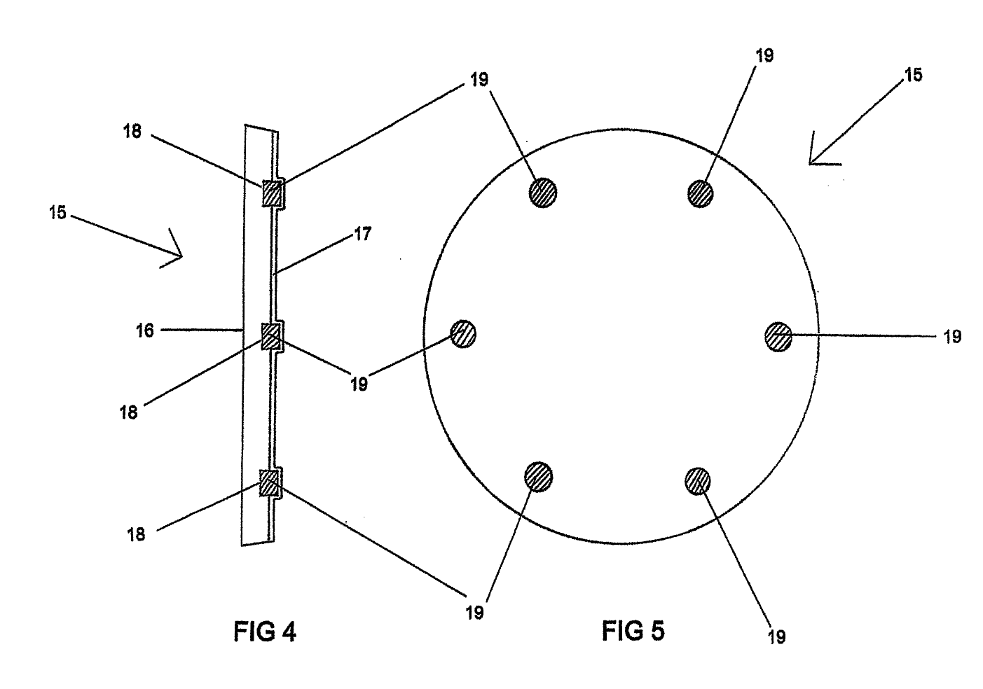

FIGS. 4 and 5 illustrate a lighting element moving means in the form of a lens unit 15. The lens unit 15 comprises a lens 16 to which is attached a backing plate 17. The lens 16 includes recesses 18 in which magnets 19 sit The magnets 19 are enclosed by the lens 16 on one side and the backing plate 17 on the other. Alternatively, the lens unit 15 may be cast as a single part with the magnets 19 embedded therein.

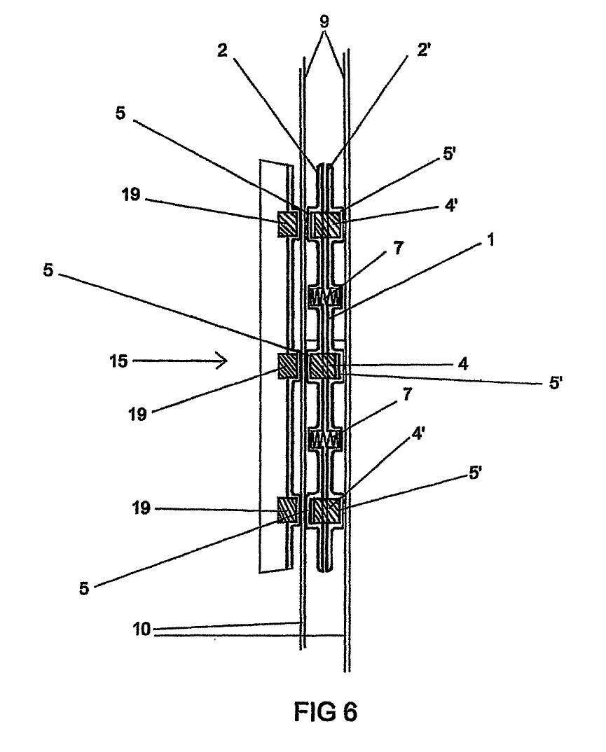

As illustrated in FIG. 6, the lens unit 15 is mounted on the outside of a glass pane 10, and is aligned with a lighting element 1. The magnets 19 of the lens unit 15 are attracted to the magnets 4, 4′ of the lighting element 1. In this configuration the plate 2′ is caused to bend so that the outer surface of recesses 5′ are pulled away from the inner surface of the glass pane 10, against the force of the springs 7. The reduction in friction is sufficient to allow the lighting element 1 to be moved about within the glass panes 10 by a person grasping and moving the lens unit 15.

When the lens unit 15 is removed, the action of the springs 7 forces the plates 2, 2′ apart so that the outer surfaces of recesses 5, 5′ press against the inner surfaces of the glass panes 10.

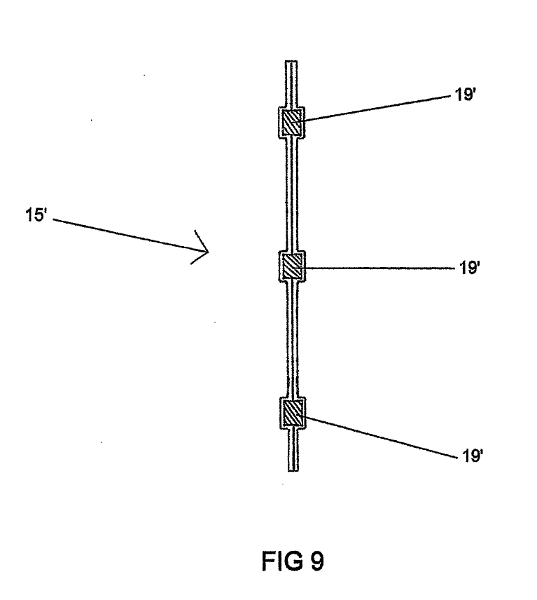

FIG. 9 illustrates a second embodiment of a lighting element moving means, in the form of a lens 15′ in which both sides of magnets 19′ may be aligned with a lighting unit The magnetic surfaces of the magnets 19′ have north and south polarities respectively. Equally, the magnets 4, 4′ have respective north and south polarities. The lens 15′ of FIG. 9 can be used to move the lighting unit from either side of the glass panes 10 by presenting one side or the other of the lens 15′ to a respective side of the glass panes 10.

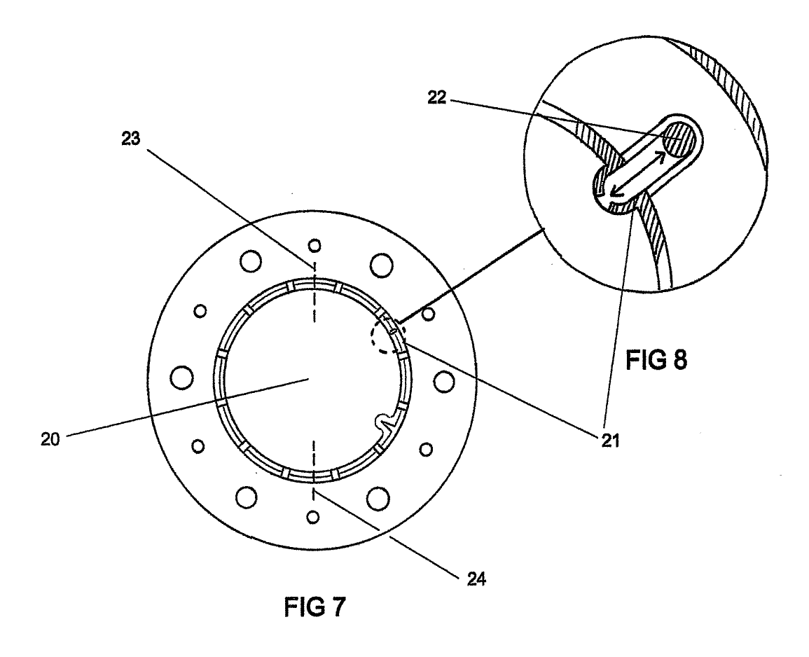

The lighting element 20 illustrated in FIGS. 7 and 8 includes a switch 21. The switch is in the form of an electrically conductive ball bearing 22, which is movable between open and closed positions. The switch is operated by rotating the lighting element 20 so that the position of the switch element changes. The position of the ball bearing is controlled by gravity. When the switch 21 is less than 90 degrees away from top dead centre 23, the switch is closed and electricity is conducted to the LED's. When the switch 21 is less than 90 degrees from bottom dead centre 24 the switch 21 is open and the LED's are off. The gravity switch allows the lighting elements to be switched on and off simply by rotating them. This switch may also take the form of a mercury reed switch.

In the example, the LED's are powered by a battery or by mains electricity through a transformer. The lighting system of the invention may include solar energy collectors for collecting solar energy and converting the collected energy into electricity. Such electricity would be stored in a suitable storage device, such as a rechargeable battery, for use by the LED's when outside light conditions have dimmed.

In use, a lighting system may comprise two spaced apart panes of glass 10 with a plurality of lighting elements located therebetween. Each lighting element 1 may be provided with a lens unit 15, alternatively only one or some of the lighting elements 1 may be provided with a lens unit 15. Where fewer lens units than lighting elements are provided, it may be necessary to remove a lens unit 15 from one lighting element 1 and move the lens unit to another lighting element, for example if the other lighting unit is to be moved. Alternatively, the lighting element moving means may not be a lens, and may be used simply to move the lighting elements from one location to another. In this alternative, it would be normal to provide fewer moving means than lighting elements.

1. A lighting element comprising at least one light, means for delivering electricity to the or each light, a pair of spaced apart plates, at least one magnet located between the said plates and biasing means for biasing the said plates apart, wherein a magnet is attached to one of the pair of plates.

2. A lighting element according to claim 1, wherein at least one magnet is attached to one of the pair of plates, and at least one magnet is attached to the other of the pair plates.

3. A lighting element according to claim 1, wherein the at least one light is mounted on a light mount supported by the said pair of plates.

4. A lighting element according to claim 1, comprising a plurality of lights.

5. A lighting element according to claim 1, wherein the said at least one light is a light emitting diode.

6. A lighting element according to claim 1, wherein at least one magnet housing is formed in each of the said pair of plates, the at least one magnet housing of one plate being substantially aligned with a magnet housing of the other plate, and wherein a magnet is located in the at least one magnet housing.

7. A lighting element according to claim 6, wherein a magnet located in a magnet housing of one plate of the pair and attached to that plate is slidably located in a magnet housing of the other plate of the pair.

8. A lighting element according to claim 1, wherein at least one biasing means housing is formed in each of the said pair plates, the at least one biasing means housing of one plate being substantially aligned with a biasing means housing of the other plate, and wherein a biasing means is located in the at least one biasing means housing.

9. A lighting element according to claim 8, wherein at least one magnet housing is formed in each of the said pair of plates, at least one magnet housing of one plate being substantially aligned with a magnet housing of the other plate, and wherein a magnet is located in the at least one magnet housing, and wherein the at least one biasing means extend between and are located in biasing means housings of each of the pair of plates.

10. A lighting element according to claim 8, wherein the at least one biasing means comprises a compression spring.

11. A lighting element according to claim 1, further comprising a switch for connecting and disconnecting electrical power to the light.

12. A lighting element according to claim 11, wherein the switch is selected from a gravity switch and a mercury reed switch.

13. A lighting element according to claim 1, wherein the plates are formed from a material selected from a transparent plastics material and an opaque plastic material.

14. A lighting system comprising a lighting element as claimed in claim 1 and a lighting element moving means.

15. A lighting system according to claim 14, wherein the lighting element moving means includes at least one magnet and when the said at least one magnet is aligned with a magnet of the lighting element the said lighting element and moving means are attracted to each other.

16. A lighting system according to claim 15, wherein the said moving means has two faces, and wherein the at least one magnet extends axially between the two surfaces such that each of the two faces of the moving means includes magnetic surfaces of the said magnets.

17. A lighting system according to claim 14, further comprising a pair of spaced apart sheets, the sheets being transparent or two way mirrored, each sheet being provided with an electrically conductive layer for delivering power to the lighting element, wherein the lighting element is movably mounted between the sheets and wherein the biasing means force outer surfaces of the plates into contact with inner surfaces of the sheets.

18. A lighting system according to claim 17, wherein aligning the magnets of the moving means with the magnets of the lighting element causes one of the plates to be pulled towards the moving means and away from the inner surface of one of the sheets against the biasing force of the said biasing means.

19. A lighting system according to claim 14, wherein the lighting element moving means is a lens unit.

20. A lighting system according to claim 14, comprising a plurality of lighting elements and at least a single lens unit.

21.-24. (canceled)
